(19) United States
(12) Patent Application Publication
(10) Pub. No.: US 2006/0020408 A1
(43) Pub. Date: Jan. 26, 2006

(54) Methodology for prediction of shallow groundwater levels

(76) Inventors: George M. Cole, Monticello, FL (US); Sanford N. Young, Tallahasse, FL (US); Kay Young, Tallahassee, FL (US)

Correspondence Address: J. WILEY HORTON, ESQUIRE;Pennington, Moore, Wilkinson, Bell & Dunbar, P.A., 2d Floor, 215 S. Monroe Street, Tallahassee, FL, 32301, US

(21) Appl. No.: 11/122,830

(22) Filed: May 5, 2005

Related U.S. Application Data
(63) Continuation-in-part of application No. 10/640,391, filed on Aug. 14, 2003, now abandoned.

(51) Int. Cl. G01F 25/00

(52) U.S. Cl. 702/100

(57) ABSTRACT

A method for prediction of groundwater level fluctuation. This approach involves using groundwater observations for the determination of rate of decline due to infiltration and rate of rise dues to precipitation for the groundwater level at a site, followed by use of those rates with historic precipitation records to estimate the extent of historic saturation and inundation periods at the site. This information can then be used as an objective criterion for the delineation of jurisdictional wetlands and other similar applications.

### BACKGROUND OF THE INVENTION

1. Field of the Invention

This invention relates generally to hydrologic wetland models. More specifically, the invention comprises a method for prediction of shallow groundwater levels for wetland classification.

2. Description of the Related Art

The definition of wetlands for jurisdictional purposes has traditionally been based on vegetative and/or soil indicators. As the word “indicators” suggests, the definitions have been based on indicators of or proxies for water presence, as opposed to actual water presence. These traditional methodologies are generally not very effective for precisely defining boundaries of wetlands. In addition, traditional methodologies often do not reflect changed conditions where drainage of the wetland areas has occurred. This often has resulted in prolonged and bitter disputes over the interpretation of vegetative and soil evidence. Accordingly, it is desirable to have more objective criteria for classification of wetlands.

As a result of deficiencies of traditional “indicator” methods, some regulatory agencies have implemented regulatory changes which allow the classification of an area to be changed if reliable hydrologic records or data indicate that the area does not have the hydrologic properties of a wetland. The factors that are generally considered include the degree of inundation and saturation an area experiences over time. “Inundation” generally describes a condition in which water from any source regularly and periodically covers a land surface. “Saturation” generally describes a condition where the water table is at or close to the surface.

Despite the apparent willingness on the part of regulatory agencies to consider hydrologic evidence as part of their classification scheme, current methods of collecting and interpreting hydrologic data have been ineffective and their use has been limited. For example, one standard means for using hydrologic data for such an application involves simply digging a pit in the soil and observing the current water level. This sort of observation is short-sighted and does not consider changes in the level due to infiltration and rainfall response with time.

### BRIEF SUMMARY OF THE INVENTION

The present invention comprises a method for prediction of groundwater level fluctuation. This approach involves using groundwater observations for the determination of site specific rate of decline due to infiltration and rate of rise dues to precipitation. These rates are then used with historic precipitation records to estimate the extent of historic saturation and inundation periods at the site. This information can then be used as an objective criterion for the delineation of jurisdictional wetlands and other similar applications.

### BRIEF DESCRIPTION OF THE SEVERAL VIEWS OF THE DRAWINGS

FIG. 1 is a flowchart, illustrating the present invention.

FIG. 2 is a graph, showing the relationship between groundwater level and rainfall for a particular site.

FIG. 3 is a graph, showing the relationship between groundwater level and rainfall for a particular site along with predicted water levels from a best-fit model.

### REFERENCE NUMERALS IN THE DRAWINGS

10 modeling process

12 groundwater observation

14 rainfall observation

16 rainfall response and infiltration rate determination

18 site model creation

20 historic rainfall records

22 groundwater level estimation

24 determining periods of long-term saturation and inundation

26 applying determined periods of saturation and inundation to wetland criteria

28 determining limits of wetlands

### DETAILED DESCRIPTION OF THE INVENTION

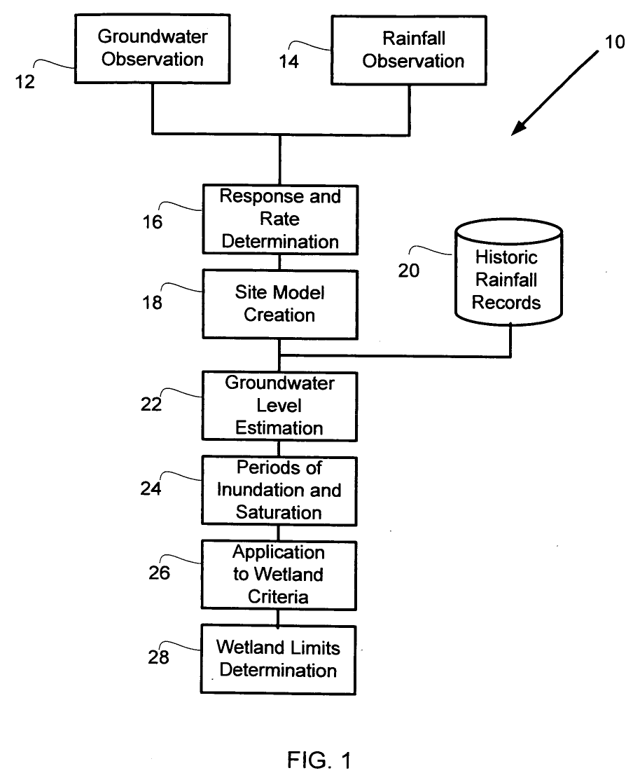

An overview of a method for prediction of shallow groundwater level fluctuation for wetland determination is illustrated in FIG. 1. The process initially involves rainfall response and infiliration rate determination 16 utilizing on-site groundwater observation 12 and rainfall observation 14 for a particular region. Groundwater observation 12 and rainfall observation 14 are data acquisition steps. Various techniques are known in the art for this type of data acquisition. Commonly used techniques include manual depth readings in shallow wells, manual reading gauges, and the use of automated sensors. The purpose of these steps is to collect information about how groundwater levels are affected by rainfall for a particular site. Whatever method is used, it is desirable for the user to track the groundwater level and rainfall quantities over time for the site. In order to create a more accurate model, observations should be made with a minimum duration covering several rainfall events and several periods of no precipitation.

Once the user has performed on-site groundwater observation 12 and rainfall observation 14, rainfall response and infiltration rates can be determined for the region. This involves calculating a “rate of decline” and a “rainfall response” for the site or region. A generalized groundwater model expression can be used to determine “decline” and “rainfall response.” Each of these concepts will be described in more detail subsequently. For any day (i), the depth of groundwater, based on the depth of previous day (i−1), may be expressed as follows:
depthᵢ=depthᵢ₋₁+decline+evapotranspiration− rainfall response

In the above equation, “decline” is defined as the lowering of the groundwater level due to recession of the water into deeper levels of the ground—or infiltration. Rate of decline therefore relates the change in water level with the change in time. “Evapotranspiration” is defined as the lowering of the groundwater level due to evaporation, both from the surface and from plant life. The effect of evapotranspiration is a relatively slight seasonal variation in decline. “Rainfall response” is defined as the resulting rise in groundwater level due to rainfall.

Rainfall response and decline can be determined for a site by conducting a regression analysis using groundwater observation 12 and rainfall observation 14 for the site. The regression analysis involves determining a “rate of decline” and “rainfall response” for a site that, when used in conjunction with aforementioned equation, best describes the relationship between groundwater depth and rainfall for a site. In addition, the regression analysis determines a site-specific factor to be applied to surface evapotranspiration rate to allow for soil porosity. Various techniques or computer programs can be used to determine which values for rainfall response and decline rate create a best-fit solution to the equation. The objective of the analysis is to derive the constants for decline and rainfall response. These constants can then be incorporated back into the equation to determine historical saturation and inundation for the site as will be described subsequently.

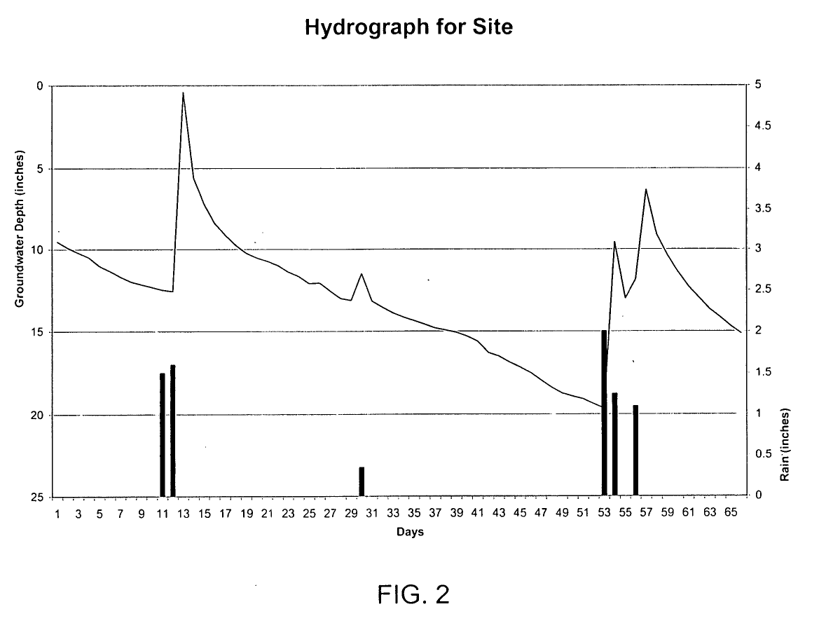

FIG. 2 shows a basic hydrograph for a site. The hydrograph shows groundwater depth over time for the site. On the bottom of the graph, periods of precipitation are noted with bars indicating the total amount of rainfall for each day. The line graph shows how the groundwater level for the site changed over time. The values for precipitation (denoted as “Rain” on the right side of the graph) and groundwater depth (the scale on the left side of the graph) are the values acquired in groundwater observation 12 and rainfall observation 14. The groundwater level is at the surface of the ground when the line reaches zero. The reader will note that groundwater levels are highest immediately following a period of precipitation. The groundwater levels decline over time until the site experiences new rainfall.

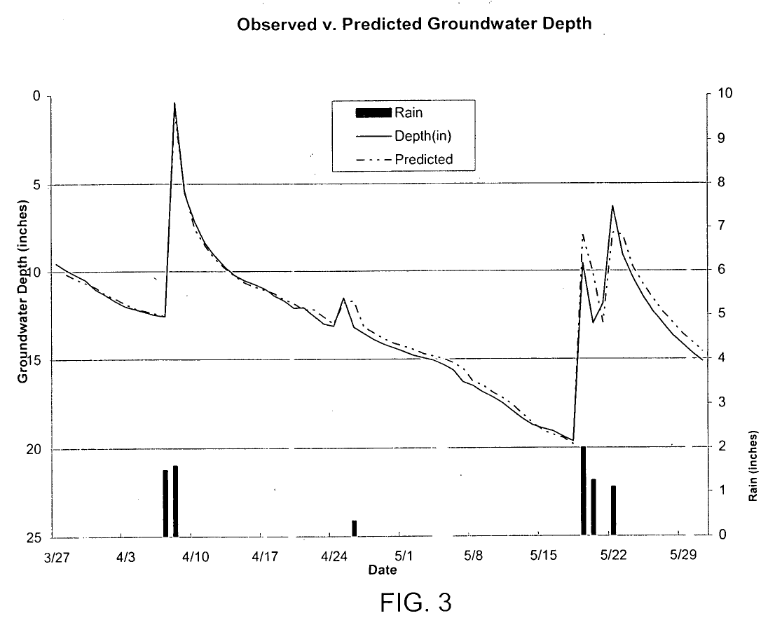

FIG. 3 shows the hydrograph of FIG. 2 but also incorporates the predicted water levels from the model for the site using the best-fit values for rainfall response and decline. In this particular model the rainfall response coefficient was 3.8, indicating that the groundwater level rises 3.8 inches for every 1.0 inch of rainfall. The infiltration or decline rate for this model is 5.4, indicating that the groundwater level falls about 5.4 inches/day due to infiltration when it is at the surface and then falls at a lesser rate with increasing depth. These coefficients for rainfall response and decline rate are inserted into the aforementioned equation for site model creation 18.

Those that are skilled in the art know that there are various methods which can be used to estimate evapotranspiration rate for a site. One example involves using the Thomthwaite method for estimation of evapotranspiration rate. Other examples include using the vapor flux or heat balance methods. In the model equation, the estimated evapotranspiration rate at the surface, derived from one of these methods for each month, is used in association with the site-specific factor derived from the regression analysis.

The validity of a model can be tested by predicting groundwater levels for the area over a period of time and comparing the predicted groundwater levels with the groundwater levels which are actually observed. This, along with statistical measurements indicating how well the model fits the data (such as the coefficient of determination), gives the user assuredness that the model is an accurate for the particular site.

Once a model has been created for a specific site, historic rainfall records 20 can be used for groundwater level estimation 22 for the site for each year. Using long-term daily rainfall records for the area together with the values for the infiltration, rainfall response, and evapotranspiration, a prediction may be performed for each year for which rainfall records are available as is described below.

The model can be used to predict the depth of groundwater levels for each successive day in the year to determine periods of saturation or inundation. “Saturation” is typically defined by wetland regulations as a critical depth for the groundwater level. When the groundwater exceeds this critical depth, the site is deemed to be saturated. “Inundation” generally means that the surface of the ground is covered with water. Accordingly, the model allows for determining periods of long-term saturation and inundation 24, where periods of saturation or inundation can be identified. This particular step is generally influenced by the next step of the process (with reference to FIG. 1)—applying determined periods of saturation and inundation to wetland criteria 26. For example, some wetland regulations define a period of time, such as 20 consecutive days, where saturation or inundation must exist in an ordinary year before an area is determined a wetland. “Wetland criteria,” therefore typically includes both a time element and a groundwater level depth element. Accordingly if the site is in a jurisdiction that adopts a 20 day saturation rule, step 24 involves identifying how many times a particular site exceeds the maintains a groundwater level exceeding the critical depth for at least 20 days.

If the prediction of past groundwater levels indicates that there have been periods of saturation for at least the number of days defined by the controlling regulations for at least half of the years for which rain records are available, the site could be considered as wetlands under those criteria. Obviously other specific criteria could be adopted for defining an area as a wetland based on the above described analysis. For example, a state or agency may decide to describe an area as a wetland if it had a period of saturation exceeding 30 days for any of the past five years. The use of alternate criteria does not depart from the spirit and scope of the present invention.

Once a particular observation site has been deemed a wetland, it is generally desirable to determine how much area around the site is also encompassed by the wetland. Determining the limit of wetlands 28 allows the user to determine the spatial extent of jurisdictional wetland. One way to accomplish this is by establishing an array of observation wells at which the above described determination of rates of decline and rainfall response are made. Process steps 12, 14, 16, and 18 can be repeated for each of the observation wells in the array.

The easiest way to visualize this step of the process is by envisaging the array of observation wells as discrete grid points on a two dimensional map. The observation wells can be placed at fixed distances from each other, although the wells could also be spread around in a more sporadic fashion. For the purposes of this description, the other observation wells can be understood as neighboring wells in relation to a well that has been determined to exceed the jurisdictional wetland criteria. Each neighboring well therefore provides a way to study the rates of decline and rainfall response for neighboring regions to a predetermined wetland region. Using the resulting rates of decline and rainfall response, an isoline map may be prepared using a contouring process such as kriging. The isoline associated with the rate of decline that, with the average rainfall response rate for the area, meets the wetland saturation criteria for exactly half of the years would approximate the limits of the wetland.

The aforementioned method for prediction of shallow groundwater levels for wetland delineation is better understood by the following example. A particular region was defined as a region of concern because vegetative and soil evidence indicated that the region's ecosystem behaved similarly to known wetland areas. To determine if the area hydrologically behaved like a “wetland” the aforementioned modeling process 10 was used.

First, an observation well was installed so that groundwater levels for the region could be studied. A rain gauge was placed near the observation well so that daily rainfall could be studied. Every day for a period of 65 days, a person was sent to the field to note how much precipitation had occurred over the past 24 hours (rainfall observation 14) and what the groundwater level was at the observation well (groundwater observation 12). The observation period was allowed to run for 65 days so that data could be obtained for several periods of precipitation and several periods of no precipitation. A sample of data that was obtained for the site is listed in Table One below.

TABLE ONE
Rainfall Observation and Groundwater Observation for Region

| Date | Rainfall (in) | Depth (in) |
|---|---|---|
| 3/27/2003 | 0 | 9.54 |
| 3/28/2003 | 0 | 9.912 |
| 3/29/2003 | 0 | 10.212 |
| 3/30/2003 | 0 | 10.512 |
| 3/31/2003 | 0 | 11.04 |
| 4/1/2003 | 0 | 11.352 |
| 4/2/2003 | 0 | 11.712 |
| 4/3/2003 | 0 | 12.012 |
| 4/4/2003 | 0 | 12.168 |
| 4/5/2003 | 0 | 12.336 |
| 4/6/2003 | 1.5 | 12.504 |
| 4/7/2003 | 1.6 | 12.588 |
| 4/8/2003 | 0 | 0.408 |
| 4/9/2003 | 0 | 5.58 |
| 4/10/2003 | 0 | 7.176 |
| 4/11/2003 | 0 | 8.364 |
| 4/12/2003 | 0 | 9.12 |
| 4/13/2003 | 0 | 9.744 |
| 4/14/2003 | 0 | 10.236 |
| 4/15/2003 | 0 | 10.536 |
| 4/16/2003 | 0 | 10.752 |
| 4/17/2003 | 0 | 10.992 |
| 4/18/2003 | 0 | 11.4 |
| 4/19/2003 | 0 | 11.688 |
| 4/20/2003 | 0 | 12.108 |
| 4/21/2003 | 0 | 12.084 |
| 4/22/2003 | 0 | 12.564 |
| 4/23/2003 | 0 | 13.008 |
| 4/24/2003 | 0 | 13.14 |
| 4/25/2003 | 0.35 | 11.52 |
| 4/26/2003 | 0 | 13.188 |
| 4/27/2003 | 0 | 13.548 |
| 4/28/2003 | 0 | 13.896 |
| 4/29/2003 | 0 | 14.148 |
| 4/30/2003 | 0 | 14.364 |
| 5/1/2003 | 0 | 14.568 |
| 5/2/2003 | 0 | 14.796 |
| 5/3/2003 | 0 | 14.928 |
| 5/4/2003 | 0 | 15.072 |
| 5/5/2003 | 0 | 15.312 |
| 5/6/2003 | 0 | 15.612 |
| 5/7/2003 | 0 | 16.284 |
| 5/8/2003 | 0 | 16.488 |
| 5/9/2003 | 0 | 16.848 |
| 5/10/2003 | 0 | 17.136 |
| 5/11/2003 | 0 | 17.472 |
| 5/12/2003 | 0 | 17.928 |
| 5/13/2003 | 0 | 18.36 |
| 5/14/2003 | 0 | 18.72 |
| 5/15/2003 | 0 | 18.9 |
| 5/16/2003 | 0 | 19.056 |
| 5/17/2003 | 0 | 19.356 |
| 5/18/2003 | 2 | 19.644 |
| 5/19/2003 | 1.25 | 9.564 |
| 5/20/2003 | 0 | 13.02 |
| 5/21/2003 | 1.1 | 11.88 |
| 5/22/2003 | 0 | 6.312 |
| 5/23/2003 | 0 | 9.096 |
| 5/24/2003 | 0 | 10.38 |
| 5/25/2003 | 0 | 11.424 |
| 5/26/2003 | 0 | 12.3 |
| 5/27/2003 | 0 | 12.984 |
| 5/28/2003 | 0 | 13.668 |
| 5/29/2003 | 0 | 14.16 |
| 5/30/2003 | 0 | 14.676 |
| 5/31/2003 | 0 | 15.132 |

The surface evapotranspiration rate was computed for each day for the region using the aforementioned Thomthwaite method. The computed values for evapotranspiration rate for each day are listed in Table Two below.

TABLE TWO
Daily Evapotranspiration Rate Determination for the Region

| Date | Evapotranspiration rate |
|---|---|
| 3/27/2003 | 0.057 |
| 3/28/2003 | 0.057 |
| 3/29/2003 | 0.057 |
| 3/30/2003 | 0.057 |
| 3/31/2003 | 0.057 |
| 4/1/2003 | 0.088 |
| 4/2/2003 | 0.088 |
| 4/3/2003 | 0.088 |
| 4/4/2003 | 0.088 |
| 4/5/2003 | 0.088 |
| 4/6/2003 | 0.088 |
| 4/7/2003 | 0.088 |
| 4/8/2003 | 0.088 |
| 4/9/2003 | 0.088 |
| 4/10/2003 | 0.088 |
| 4/11/2003 | 0.088 |
| 4/12/2003 | 0.088 |
| 4/13/2003 | 0.088 |
| 4/14/2003 | 0.088 |
| 4/15/2003 | 0.088 |
| 4/16/2003 | 0.088 |
| 4/17/2003 | 0.088 |
| 4/18/2003 | 0.088 |
| 4/19/2003 | 0.088 |
| 4/20/2003 | 0.088 |
| 4/21/2003 | 0.088 |
| 4/22/2003 | 0.088 |
| 4/23/2003 | 0.088 |
| 4/24/2003 | 0.088 |
| 4/25/2003 | 0.088 |
| 4/26/2003 | 0.088 |
| 4/27/2003 | 0.088 |
| 4/28/2003 | 0.088 |
| 4/29/2003 | 0.088 |
| 4/30/2003 | 0.088 |
| 5/1/2003 | 0.136 |
| 5/2/2003 | 0.136 |
| 5/3/2003 | 0.136 |
| 5/4/2003 | 0.136 |
| 5/5/2003 | 0.136 |
| 5/6/2003 | 0.136 |
| 5/7/2003 | 0.136 |
| 5/8/2003 | 0.136 |
| 5/9/2003 | 0.136 |
| 5/10/2003 | 0.136 |
| 5/11/2003 | 0.136 |
| 5/12/2003 | 0.136 |
| 5/13/2003 | 0.136 |
| 5/14/2003 | 0.136 |
| 5/15/2003 | 0.136 |
| 5/16/2003 | 0.136 |
| 5/17/2003 | 0.136 |
| 5/18/2003 | 0.136 |
| 5/19/2003 | 0.136 |
| 5/20/2003 | 0.136 |
| 5/21/2003 | 0.136 |
| 5/22/2003 | 0.136 |
| 5/23/2003 | 0.136 |
| 5/24/2003 | 0.136 |
| 5/25/2003 | 0.136 |
| 5/26/2003 | 0.136 |
| 5/27/2003 | 0.136 |
| 5/28/2003 | 0.136 |
| 5/29/2003 | 0.136 |
| 5/30/2003 | 0.136 |
| 5/31/2003 | 0.136 |

As explained previously, for any day (i), the depth of groundwater, based on the depth of previous day (i−1), may be expressed as follows:
depthᵢ=depthᵢ₋₁+decline+evaportranspiration−rainfall response

This expression can also be written as follows:
depthᵢ=depthᵢ₋₁+decline+K₁(depthᵢ₋₁)+K₂(depthᵢ₋₁)²+K₃(rainfallᵢ₋₁)+K₄(evapotranspiration at surface);
where K₁, K₂, K₃ and K₄ are constants.

Regression analysis was then performed via computer program on the aforementioned groundwater levels, rainfall amounts, and evapotranspiration rates to determine the values of K₁ and K₂, K₃ and K₄. This corresponds with rainfall response and infiltration rate determination 16 step of modeling process 10. The equation that best described the data for the region was depthᵢ=depthᵢ₋₁+5.4−0.7(depthᵢ₋₁)+0.03(depthᵢ₋₁)²−3.8(rainfallᵢ₋₁)−3.8(evaportranspiration at surface). Accordingly, the determined rainfall response for the region was 3.8, indicating that the groundwater level rises 3.8 inches for every 1.0 inch of rainfall. From the other parameters in the model, it may be seen that the groundwater level falls about 5.4 inches per day to infiltration when it is at the surface and then falls at a lesser rate with increasing depth.

Historic rainfall records 20 were then obtained for the region. Rainfall amounts were collected for a period of time spanning 50 years. For a conservative estimate, the initial depth of the groundwater level for each year was assumed to be zero (e.g. the groundwater level was assumed to be at the surface of the ground). Based on the above equation, groundwater levels were estimated for successive years over the entire 50 year period. Since the model for the site has already been created, the calculation is very straightforward. To calculate groundwater level for a successive day, groundwater level and the rainfall amount values for the previous day were input into the equation. This process was repeated until values for groundwater levels for every day over the period were computed. This corresponds with groundwater level estimation 22 step of modeling process 10.

Since the region is located in a jurisdiction that defines a wetland as an area having a groundwater level exceeding 6 inches below the surface (critical depth) for at least 20 days, the data was sorted to determine periods of long-term saturation and inundation 24 meeting the regulatory criteria for the region over the 50 year time period. Although the region exceeded the critical depth on numerous occasions, none of the periods of saturation exceeded the duration required by the wetland criteria for the jurisdiction.

Although the preceding description contains significant detail, it should not be construed as limiting the scope of the invention but rather as providing illustrations of the preferred embodiments of the invention. Accordingly, the scope of the invention should be defined by ensuing patent claims and not the examples given.

Having herein described our invention, we claim:

1. A method for prediction of shallow groundwater level fluctuation comprising:
a. defining a site for which said shallow groundwater level fluctuation is to be determined;
b. observing groundwater levels for said site for a period of time;
c. observing rainfall for said site for said period of time;
d. calculating a rate of decline for said site;
e. calculating a rainfall response for said site;
f. providing historic precipitation records applicable to said site; and
g. applying said rate of decline and said rainfall response to said historic precipitation records to determine an estimated extent of historic saturation and inundation periods.

2. The method of claim 1, further comprising the step of calculating a site-specific evapotranspiration factor.

3. The method of claim 1, further comprising the step of applying said estimated extent of historic saturation and inundation periods to jurisdictional wetland criteria to determine if said site meets said jurisdictional wetland criteria.

4. The method of claim 2, further comprising the step of applying said estimated extent of historic saturation and inundation periods to jurisdictional wetland criteria to determine if said site meets said jurisdictional wetland criteria.

5. The method of claim 3, further comprising the steps of:
a. determining an array of rates of declines and rainfall responses for neighboring sites; and
b. comparing said rate of decline and said rainfall response for said site and said array of rates of declines and rainfall responses for neighboring sites; and
c. determining a limit of a wetland by identifying an isoline among said site and said neighboring sites, wherein said isoline is associated with said rate of decline and said rainfall response for said site and said rates of decline and rainfall response for said neighboring sites that meet said jurisdictional wetland criteria.

6. The method of claim 4, further comprising the steps of:
a. determining an array of rates of declines and rainfall responses for neighboring sites; and
b. comparing said rate of decline and said rainfall response for said site and said array of rates of declines and rainfall responses for neighboring sites; and
c. determining a limit of a wetland by identifying an isoline among said site and said neighboring sites, wherein said isoline is associated with said rate of decline and said rainfall response for said site and said rates of decline and rainfall response for said neighboring sites that meet said jurisdictional wetland criteria.

7. A method for prediction of shallow groundwater level fluctuation comprising:
a. defining a site for which said shallow groundwater level fluctuation is to be determined;
b. observing groundwater levels for said site for a period of time;
c. collecting values for said groundwater levels for said site for said period of time;
d. observing amounts of rainfall for said site for said period of time;
e. collecting values for said amounts of rainfall for said site for said period of time;
f. creating a model for said site, said model mathematically describing the relationship between said values for said groundwater levels and said values for said amounts of rainfall for said region for said period of time;
g. providing historic precipitation records applicable to said site; and
h. applying said model to said historic precipitation records to determine an estimated extent of historic saturation and inundation periods.

8. The method of claim 7, further comprising the step of applying said estimated extent of historic saturation and inundation periods to jurisdictional wetland criteria to determine if said site meets said jurisdictional wetland criteria.
